(19) United States
(12) Patent Application Publication
(10) Pub. No.: US 2009/0026019 A1
(43) Pub. Date: Jan. 29, 2009

(54) Forklift Mast

(75) Inventor: Janne Polvilampi, Helsinki (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: ROCLA OYJ, Jarvenpaa (FI)

(21) Appl. No.: 11/631,664

(22) PCT Filed: Jul. 5, 2005
(86) PCT No.: PCT/FI05/00317

§ 371 Date: Aug. 20, 2008

(30) Foreign Application Priority Data
Jul. 6, 2004 (FI) 20040942

(51) Int. Cl. B66F 9/08; B21D 47/00

(52) U.S. Cl. 187/238; 29/897.31

(57) ABSTRACT

The invention relates to the mast-hydraulic cylinder construction (4, 5) of a two or multiple-stage forklift mast. The substantially vertical beams (4, 5) and cylinder liners (6) of the solid mast structure form an integrated structure (4, 5), in which the cylinder liners (6) consist of ducts integrated within the beams (4, 5), with the mass centre of the cross-section of the integrated structures being at the centre of the cylinder liner (6) or in its immediate vicinity so that the integrated structure (4, 5) can be manufactured by heat extrusion or cold drawing, and in that the integrated structure (4, 5) comprises a first protrusion (14), whose surface is a bearing surface (17) for a roller bearing (16), and a second protrusion (15) for providing a mass centre at the centre of the cylinder liner (6), and a support surface (18, 19) substantially transverse to the direction of movement of the forklift. The invention also relates to a method for producing an integrated structure (4, 5).

### CROSS REFERENCE TO RELATED APPLICATIONS

This application is for entry into the U.S. national phase under §371 for International Application No. PCT/FI05/000315 having an international filing date of Jul. 5, 2005, and from which priority is claimed under all applicable sections of Title 35 of the United States Code including, but not limited to, Sections 120, 363 and 365(c), and which in turn claims priority under 35 USC §119 to Finnish Patent Application No. 20040942 filed on Jul. 6, 2004.

### TECHNICAL FIELD

The invention relates to a forklift mast. More specifically, the invention relates to a forklift mast comprising two or more stages, which is either solidly or tiltingly fixed to the frame and is formed of a first pair of substantially vertical beams, which are interconnected by at least one substantially horizontal beam, the parts forming a solid mast structure, with at least one second pair of substantially aligned vertical beams disposed in the vicinity of the construction, the beams being interconnected by at least one substantially horizontal beam and the parts forming a cradle, which is disposed to move vertically relative to the solid mast construction under the propulsion of hydraulic cylinder pistons, the movement and the force being transmitted either directly or through wire cables from these to a hoisting cradle, the substantially vertical beams of the solid mast structure and hydraulic cylinders generating a vertical hoisting movement forming an integrated structure, in which the cylinder liners consist of ducts integrated within the beams, and to a method for manufacturing the construction.

### BACKGROUND OF THE INVENTION

A mast forklift is a truck moving on at least three wheels, which comprises a mast construction consisting of a solid mast construction and a hoisting cradle. It may additionally comprise moving intermediate cradles, by means of which the lifting height of the forklift is increased. This design provides a two or multiple-stage forklift. The forklift mast is attached solidly or by articulation to the frame of a forklift as defined by the standard EN 1726-1 or EN 1726-2, e.g. FIG. 1. The mast stages move relative to each other under the propulsion of separate hydraulic cylinder pistons, from which the movement and the force are transmitted either directly or through chains or wire cables to the load-hoisting cradle. The mast and its steps constitute a telescopic guide system, in which the load is transmitted from the load-hoisting cradle through the guide rolls to the frame structure of the forklift. Mast forklifts are used e.g. for conveying containers, boxes and similar goods e.g. into a rack system or vice versa.

The forklift mast and the cradles have typically been formed from vertically disposed profiles, such as I-beams, which have been interconnected by means of cross members, the mast and the cradles having been connected so as to be allowed to move vertically relative to each other by the intermediation of guide ball bearings. The outermost intermediate cradle moves via guide roll bearings vertically along the profiles of the stationary mast structure. Accordingly, the innermost intermediate cradles are movable relative to the outermost intermediate cradles and the hoisting cradle moves relative to the innermost intermediate cradle. This arrangement provides a telescopic structure used for hoisting goods. The telescopic structure is typically moved by means of hydraulic cylinders.

In view of the purpose of use of the mast forklift, the forklift preferably has optimal visibility in all directions, a wide and unobstructed field of view into the driving direction of the forklift being especially important. In addition, the forklift is required to have a small size and good mobility, since it often moves in narrow storage spaces. The construction used in current mast forklifts reduces the driver's field of view in the principal observing direction due to the mast structure and the broad dead area caused by the associated hoisting cylinders. In such mast forklifts currently used, the hydraulic cylinders consist of a separate cylinder liner construction and piston construction, which have preferably been disposed either laterally of or behind the mast construction.

FI patent specification 111626 B discloses a solution in which a cylinder liner has been combined with a mast structure. The mast profile can be manufactured by heat extrusion or cold drawing, and it comprises two protrusions, with pivoting and support associated with the drive of the mast disposed in the first protrusion. The second protrusion of the mast has been manufactured in order to allow manufacture by the methods mentioned above and to place the centre of the cross-section of the mast profile in the centre or in the immediate vicinity of the cylinder liner.

In addition, JP A 10-152300 also discloses a solution in which the cylinder liner is connected with the mast structure. The solution comprises a mast structure manufactured from two special profiles by means of slide bearings and including two support surfaces in the main loading direction of the forklift.

However, DE patent specification 32 00 287 A1 discloses a construction in which a tubular cylinder construction has been connected solidly with a U-shaped beam. The tubular construction is described as connected either with the end of the U-shaped beam or at the centre of the web on the opposite side of the protrusions. This known construction nevertheless involves elaborate and costly manufacture.

The solution of DE 32 00 287 A1 can be implemented in practice e.g. by welding a tubular construction forming a cylinder to the U-shaped beam. An integral construction produced in this manner is costly and its manufacture will entail a plurality of work steps requiring high precision and special professional skill. Other methods for producing the integral beam in accordance with this reference include casting or machining, among other things. However, none of the manufacturing methods mentioned above represents a reasonable manner of producing an integral beam. Moreover, if the cylinder construction is attached to the end of a U-shaped beam, this will result in a very long structure viewed in the direction of movement of the forklift, leading in turn to reduced manipulability of the forklift. The most advantageous method would be manufacture of the integral beam by heat extrusion or cold drawing.

The cylinder liners of integral beams have conventionally been sealed by machining a sealing surface inside the cylinder liner of the integral beam and by mounting a packing box on this. The machining of the sealing surface involves an additional high-precision step in the manufacture of the integral beam, increasing the production costs in this respect. The price of an integral beam is primarily composed of the amount of steel used per metre and of the arrangement of a packing at the end of the cylinder liner.

A heat-extruded perforated profile is manufactured in the following work steps:
a boring with e.g. a 50 mm diameter is drilled in an initial blank having a diameter of e.g. 150 mm and a length of 600 mm
the initial blank is heated to red heat
an auxiliary tool is inserted through the boring in the initial blank (bar diameter 50 mm)
the initial blank is inserted through the profile model by means of the auxiliary tool.

Unless the boring is at the mass centre or its immediate vicinity, the auxiliary tool will bend and break at the last stage. The same problem arises during manufacture by cold drawing. Due to the requirement posed by this manufacturing method, the manufacture of the beams of DE 32 00 287 A1 would require a “counter load” to be added in order to bring the mass centre to the centre of the cylinder boring or in its immediate vicinity. This would result in a heavy integral beam, whose manufacture would consume a large amount of steel and which would have increased outer dimensions. A mast construction with increased dimensions, again, would obstruct the visibility excessively or have a negative impact on the mobility of the vehicle.

### SUMMARY OF THE INVENTION

The purpose of the invention is to provide a method for manufacturing an integral beam that is economically profitable and achieves a product in which the driver's field of view has only a small dead area and the mast construction is light. This invention comprises an economically competitive method for manufacturing a so-called integral beam of an integrated mast construction, in which the beam and the cylinder liner have been combined in the same beam, pivoting of the mast construction and the mast construction proper. The invention has the additional purpose of improving the rigidity of previously used integrated mast constructions in the principal loading direction. In a further preferred embodiment of the invention, the cylinder liner is sealed outside the end of the cylinder liner by attaching a packing box by welding or by any other means to the end of the cylinder liner. The solution of the invention is characterised by the features defined in the following claims.

The integral beam of the invention achieves a very advantageous rigidity to weight ratio.

The integral beam of the invention is preferably manufactured by heat extrusion or cold drawing of steel. The cylinder boring of the integral beam is located at the mass centre of the cross-section of the integral beam or in its immediate vicinity, most advantageously exactly at the mass centre. Deviations from this would immediately entail problems of heat extrusion or cold drawing, and at some stage, would prevent the use of the method depending on the process parameters. For this reason, the solutions of DE 32 00 287 A1 cannot be implemented by means of current manufacturing methods.

### BRIEF DESCRIPTION OF THE DRAWINGS

The invention is explained more in detail with reference to the accompanying drawings, in which

FIG. 1 is a side principle view 3-D of a known mast forklift,

FIG. 2 is a top cross-sectional view of the mast construction of the invention,

FIG. 3 is a partial enlargement A of the pivoting and support of the mast construction of FIG. 2,

FIG. 4 is a side view showing how the packing box is disposed at the end of the integral beam,

FIG. 5 is a cross-section of an integral beam, and

FIG. 6 is a cross-sectional view of a second preferred embodiment of an integral beam.

### DETAILED DESCRIPTION

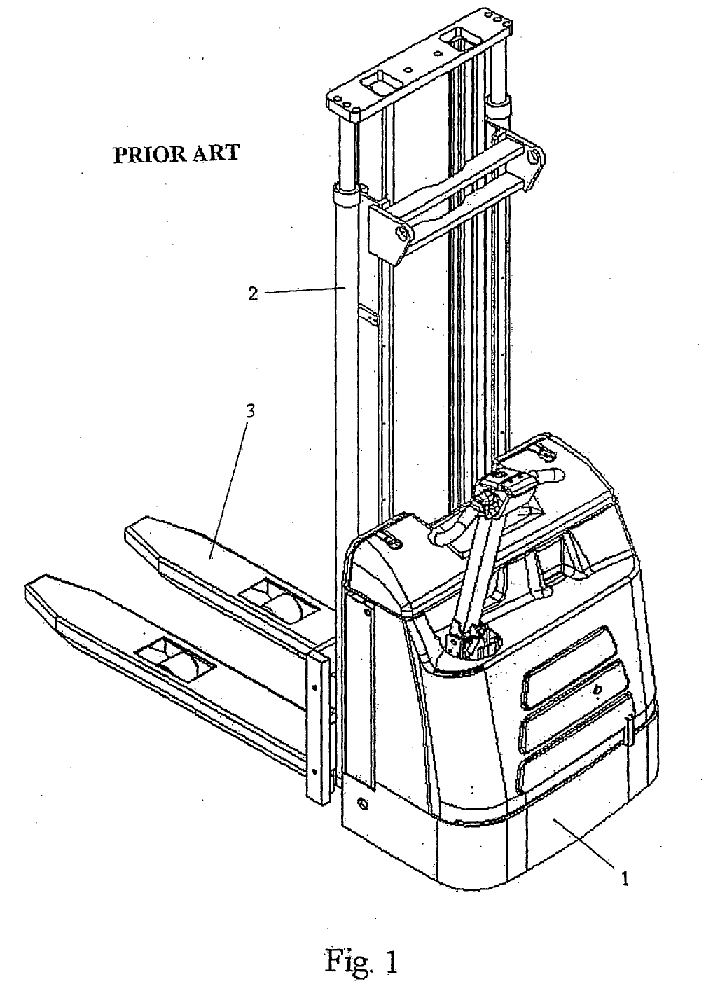

FIG. 1 illustrates a known version of a mast forklift. The frame 1 of the mast forklift comprises an attached mast construction and hydraulic cylinder construction 2, by means of which the hoisting cradle 3 can be lifted. In this case, the hoisting cradle 3 is a fork cradle. The hoisting cradle 3 is lifted in two or more steps depending on the mast construction.

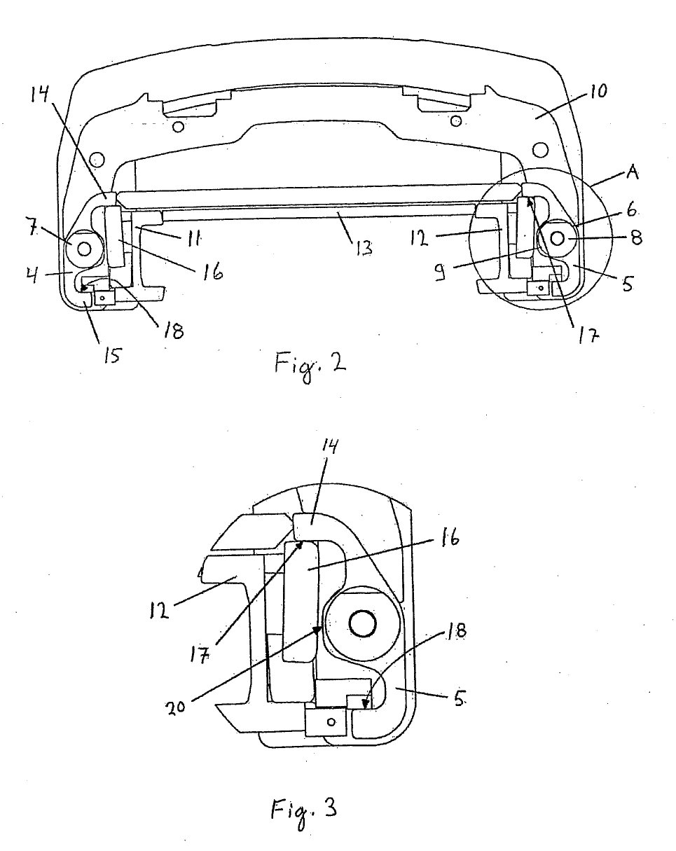

FIG. 2 is a cross-sectional top view of the mast construction of the mast forklift of the invention. The figure illustrates the integrally constructed substantially vertical beams 4 and 5, comprising integrated cylinder liners 6 with pistons 7 and 8. The cylinder liners 6 are borings extending longitudinally through the integral beams 4 and 5, the borings being sealed e.g. at their lower end by a pressure bushing or a plug and equipped at their upper end with packing boxes 9 in order to seal and guide pistons 7 and 8. The packing boxes have been mounted by welding or any similar method outside the cylinder liners, so that the inner surface of the cylinder liners does not require machining. The beams 4 and 5 have been connected to each other transversely by means of a substantially horizontal beam 10. Inside the beams 4 and 5 viewed in the lateral direction of the mast forklift, an intermediate cradle has been mounted, which consists of substantially vertical I-beams 11 and 12 and a substantially transverse beam 13. The integral beams 4 and 5 comprise a protrusion 14, which is disposed accordingly on the bearings 16 of the I-beams 11 and 12 for vertical displacement of the intermediate cradle. The surface of the protrusion 14 located closer to the cylinder liner is a bearing surface 17. The surface of the integral beam 4 and 5 closer to the cylinder liner of the second protrusion 15 forms a support surface 18, which prevents the integral beam from tilting into the other direction. The integrally constructed beams 4 and 5 may be attached to the frame of the mast forklift either solidly or tiltingly. The bearing 16 is carried out as a roller bearing.

FIG. 3 shows a partial enlargement A of FIG. 2, in which the bearing 16 of the mast construction and the supporting surface 18 are more clearly visible. The support of the I-beam 12 has been provided by utilising the two protrusions 14 and 15 of the integral beam 5. The bearing 16 moves against the bearing surface 17 of the protrusion 14 for displacement of the intermediate cradle and the support surface 18 of the protrusion 15 bears in the opposite direction of the I-beam. The I-beam 12 is principally supported by means of the bearing 16 against the bearing surface 17 of the integral beam 5, whereas the support 18 of the protrusion 15 is active merely during the start, for instance, whereby the I-beam bears momentarily in the opposite direction. Lateral support of the beams 4 and 5 relative to the direction of movement of the forklift has preferably been provided in the vicinity of the centre of the cylinder liners of the integral beams, where an even surface 20 has been provided for the support.

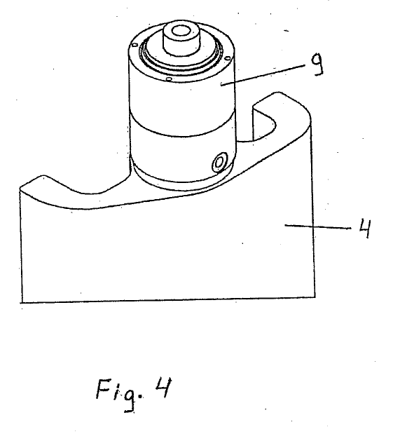

FIG. 4 is a lateral view of packing boxes 9 mounted at the ends of the cylinder liners by welding, for instance, the packing boxes guiding simultaneously the pistons 7 and 8. The packing boxes 9 can be optionally attached also by means of a separately welded sleeve to the cylinder liner, and then the packing boxes can be readily detached for service. The packing boxes are attached to the sleeve by means of a threaded joint, for instance. By placing the packing boxes 9 as discrete bodies entirely outside the actual cylinder liner, one can achieve appreciable economy in the production costs of the integral beam. Depending on the construction, the packing boxes 9 are disposed either at the upper or the lower end of the beams 4 and 5, allowing the pistons 7 and 8 to move either downwardly or accordingly in an upward direction. The cylinder liners are sealed at their opposite ends by a pressure bushing or a plug. This allows for slightly wider manufacturing tolerances of the integral beam. The sealing between the pistons 7 and 8 and the cylinder liner can also be carried out by some other known method.

The integrated constructions 4 and 5 of the mast construction, the cylinder liners and the pistons 7 and 8 reduce the dead area arising in the driver's field of view and they do not increase the length of the mast construction in the direction of movement. There is also the additional advantage of a simpler and lighter construction having a better rigidity to weight ratio and including fewer components. A reduced number of components leads to lower production costs. In addition, owing to the design of the integral beam, the manufacture of the beam can utilise economically competitive manufacturing techniques, such as heat extrusion or cold drawing. The manufacturing techniques mentioned above require the mass centre of the cross-section of the integral beam to be placed at the centre of the cylinder liner or in the immediate vicinity of this. What is more, with the packing box placed entirely as a discrete part at the end of the integral beam, one avoids a high-precision work step.

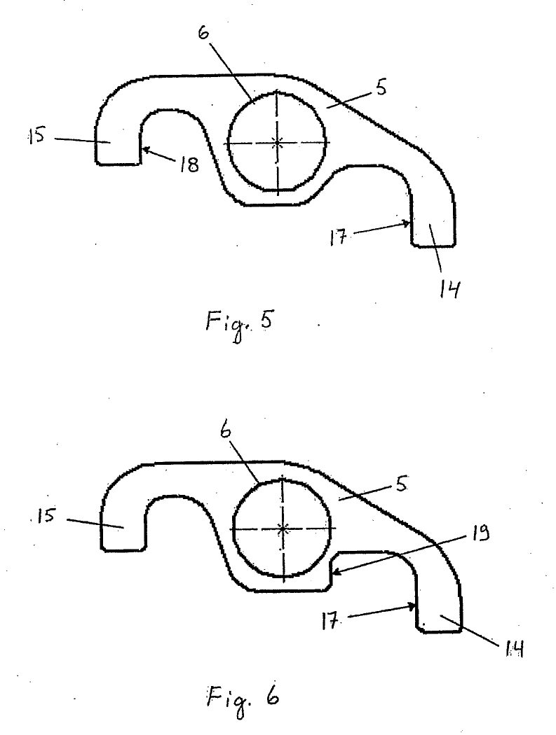

FIG. 5 is a cross-sectional view of the integral beam 5 of the invention. The mass centre of the integral beam 5 is located at the centre of the cylinder liner 6, so that the beam can be manufactured by heat extrusion or cold drawing. The integral beam 5 comprises a protrusion 4 for bearing purposes and a protrusion 15 for support purposes, and the protrusions are utilised in the positioning of the mass centre. The integral beam 5 is pivoted by supporting on the surface 17 and supported by bearing against the surface 18. The construction is imparted excellent rigidity owing to the shape of the construction in the direction of movement of the forklift, such rigidity being vital in terms of the operation of the mast construction. In addition, positioning the packing box as described above allows manufacture of a construction with a thinner wall (at the cylinder liner) than before, and this appears as a reduced raw material requirement during the manufacture of the beam.

FIG. 6 illustrates an embodiment in which the integral beam 5 is supported on the outer surface 19 of the first protrusion 14 of the cylinder liner 6. In this situation, the second protrusion 15 shifts the mass centre of the integral beam 6 as required by manufacture to the correct position and it may have any freely chosen shape. However, the protrusion 15 is preferably manufactured so as to extend in the direction of movement of the forklift with a view to maximised rigidity characteristics of the integral beam 5.

The manufacture of the integral beam of the invention requires approx. 20 kg/m of steel. The manufacture of the integral beam having the cross-section disclosed in FI 111626 B uses about 29 kg/m of steel for the same rigidity of the beam. Similarly, the manufacture of the integral beams produced by heat extrusion as in DE 32 00 287 A1 consumes about 50 kg/m of steel. Since the price per length unit of steel beam consists directly of the amount of raw material used, the solutions of these references obviously have less economical manufacture by heat extrusion or cold drawing than the beam construction of the invention. The necessary mass additions also enlarge the outer dimensions of the integral beam, so that the beam would again cover a greater part of the driver's field of view. As stated above, manufacture by welding, for instance, does not involve an economically competitive solution.

Only a number of preferred embodiments of the integral beam of the invention have been described above. However, it is obvious to those skilled in the art that there are several options of how to carry out the construction and that the following claims define the scope of protection more precisely.

What is claimed is:

1. A two or multiple-stage forklift mast, which is attached either solidly or tiltingly to a frame and which comprises a first pair of substantially vertical beams, which are interconnected by at least one substantially horizontal beam, the vertical beams and horizontal beam forming a stationary mast construction, with at least one second pair of substantially aligned vertical beams disposed in the vicinity of the construction, the second pair of beams being interconnected by at least one substantially transverse beam and the second pair of vertical beams and the transverse beam forming a cradle, which is disposed to move vertically relative to the stationary mast construction under the propulsion of pistons of hydraulic cylinders, the movement and force of the pistons being transmitted either directly or by the intermediation of chains or wire cables to a hoisting cradle, the first pair of substantially vertical beams and cylinder liners of the stationary mast construction forming an integrated construction, in which the cylinder liners comprise ducts integrated within the first pair of beams, the mass centre of the cross-section of the integrated structure being at the centre of the cylinder liner or in its immediate vicinity, so that the integrated structure can be manufactured by heat extrusion or cold drawing, wherein the integrated structure comprises a first protrusion, whose surface is substantially transverse to the direction of movement of the forklift, and a bearing surface facing the cylinder liner, the bearing surface for a roller bearing and a second protrusion for providing a mass centre at the centre of the cylinder liner or in its immediate vicinity, and a support surface substantially transverse to the direction of movement of the forklift and disposed on the second protrusion or on the outer surface of the cylinder liner facing the first protrusion.

2. The forklift mast as defined in claim 1, wherein a packing box is connected outside the second end of the integrated structure either directly to the integrated structure or through a bushing connected to the integrated structure.

3. The forklift mast as defined in claim 2, wherein the support of the integrated structure in a direction substantially transverse to the direction of movement of the forklift is provided on a planar surface located substantially in the vicinity of the centre of the cylinder liner.

4. A method for manufacturing an integrated structure of a forklift mast as defined in claim 1 by heat extrusion or cold drawing, wherein a first protrusion is produced in an integrated construction, an I-beam is pivoted by a roller bearing on a surface substantially transverse to the direction of movement of the forklift and faces a cylinder liner, and a second protrusion is produced for positioning the mass centre of the integrated construction at the centre of the cylinder liner or in the immediate vicinity of the centre, and wherein a surface substantially transverse to the direction of movement of the forklift is produced on the second protrusion or on the outer surface of the cylinder liner facing the first protrusion, this surface being used for opposite support.

5. A method as defined in claim 4, wherein a packing box is connected outside the end of the cylinder liner by welding or a similar method.

6. The forklift mast as defined in claim 1, wherein the support of the integrated structure in a direction substantially transverse to the direction of movement of the forklift is provided on a planar surface located substantially in the vicinity of the centre of the cylinder liner.
